(19) United States
(12) Patent Application Publication
(10) Pub. No.: US 2004/0044560 A1
(43) Pub. Date: Mar. 4, 2004

(54) Kiosk with body fat analyzer

(76) Inventors: Joe Giglio, Orland Park, IL (US); Fred Schiegel, Park Ridge, IL (US)

Correspondence Address: MCDERMOTT WILL & EMERY, 600 13TH STREET, N.W., WASHINGTON, DC, 20005-3096, US

(21) Appl. No.: 10/240,562

(22) PCT Filed: Apr. 5, 2001
(86) PCT No.: PCT/US01/11061

(51) Int. Cl. G06F 17/60

(52) U.S. Cl. 705/10

(57) ABSTRACT

An apparatus is provided to evaluate the physical condition of a user based on personal data provided by the user and measurements taken by the device. Results of the evaluation and health-related information that corresponds thereto are output for display on a screen and/or printed. Embodiments include a kiosk, such as a stand alone structure or a sit down unit having a touch screen, which typically shows a series of advertisements and inducements. When the user touches the screen, the screen prompts the user to enter personal information, such as age, height, gender, and general physical condition. The kiosk measures the user's weight with a built-in measuring device, instructs the user to place their hands on a set of electrodes, then performs body fat composition measurement employing conventional body fat analysis techniques, such as boielectrical impedance analysis (BIA). The kiosk outputs on the screen a body composition analysis (i.e., body fat percentage), and prints a detailed report of the results of its analysis including an assessment of the user's physical condition, recommendations, and special offers selected by the kiosk's processor based on the user's personal information and test results, such as product coupons. The user can also request information relating to a variety of issues (e.g., fitness, nutrition, weight loss, etc.) and products (e.g., magazines, health clubs, etc.).

### FIELD OF THE INVENTION

The present invention relates to a kiosk with a body fat analyzer, and more particularly to a kiosk that measures the body fat of a user and returns information to the user based on the body fat measurement.

### BACKGROUND OF THE INVENTION

Devices for providing data such as visceral fat mass, subcutaneous-visceral fat ratio and other fitness indicators as a guide to health management are well-known. Typically, impedance values are measured across two or more limbs in contact with a set of electrodes, and the impedance values and previously input personal data are used to calculate a fat mass and fat ratio. Such devices can be hand-held and portable, or part of a stationary machine; e.g., one using hand and foot electrode units.

Devices for evaluating the physical fitness of an individual are also well-known. For example, some conventional devices obtain personal data from the individual,. as through a computer keyboard, and measure the cardiovascular fitness of the individual based on at least one of heart rate, blood pressure, treadmill energy expenditure, bicycle energy expenditure, strength fitness (e.g. hand strength or isometric measurements), flexibility fitness and body composition (body fat and/or weight measurements). Overall fitness indices are calculated and outputted, as on a computer display screen or printer.

While the above conventional devices provide raw fitness statistics which may be useful to health care professionals, they do not provide follow-on information directly beneficial to the individual being evaluated, such as lifestyle, health or commercial product information. Therefore, their utility to the average individual is limited.

There exists a need for a simple-to-use apparatus for evaluating a user's physical fitness and providing useful health-related information based on the user's fitness statistics.

### SUMMARY OF THE INVENTION

An advantage of the present invention is a simple-to-use apparatus for measuring the body fat of a user after inputting personal information of the user, and outputting a fitness evaluation of the user along with lifestyle, health and product recommendations.

Additional advantages and other features of the present invention will be set forth in part in the description which follows and in part will become apparent to those having ordinary skill in the art upon examination of the following or may be learned from the practice of the invention. The advantages of the invention may be realized and obtained as particularly pointed out in the appended claims.

According to the present invention, the foregoing and other advantages are achieved in part by an apparatus comprising an input device for inputting personal data of a user; a body fat analyzer for measuring the body fat of the user; an output device for providing information to the user; and a processor for selecting the information based on the personal data and the body fat measurement of the user, and for providing the information to the output device. The outputted information comprises at least one of commercial information and health-related information.

Additional advantages of the present invention will become readily apparent to those skilled in this art from the following detailed description, wherein only the preferred embodiment of the present invention is shown and described, simply by way of illustration of the best mode contemplated for carrying out the present invention. As will be realized, the present invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIGS. 1a-1d illustrate kiosks in accordance with embodiments of the present invention.

FIG. 2 is a block diagram of an apparatus according to an embodiment of the present invention.

FIG. 3 is a flow chart illustrating an embodiment of the present invention.

FIGS. 4a-4d are flow charts illustrating an embodiment of the present invention.

FIG. 5 illustrates a Recommendation Module and an Ad Targeting Module according to the present invention.

FIGS. 6a-6e are examples of screens displayed according to an embodiment of the present invention.

### DESCRIPTION OF THE INVENTION

Conventional devices for evaluating the fitness of an individual do not provide useful information such as lifestyle, health and product recommendations corresponding to the individual's fitness evaluation results. The present invention addresses and solves this problem of conventional fitness-measuring devices.

The present invention evaluates the physical condition of a user based on personal data provided by the user and measurements taken by the device. Results of the evaluation and health-related information that corresponds thereto are output for display on a screen and/or printed. The present invention can be embodied in a “kiosk”, such as a stand alone structure or a sit down unit. The user either stands up or sits down at the kiosk (depending on its design) and faces a touch screen, which typically shows a series of advertisements and inducements. When the user touches the screen, the screen prompts the user to enter personal information, such as age, height, gender, and general physical condition. The kiosk then measures the user's weight with a built-in measuring device, and instructs the user to place his or her hands on a set of electrodes, either below the screen or mounted elsewhere. The kiosk then performs body fat composition measurement employing conventional body fat analysis techniques, such as boielectrical impedance analysis (BIA).

The kiosk outputs on the screen a body composition analysis (i.e., body fat percentage). The kiosk then prompts the user to enter their name and telephone number, and prints a detailed report of the results of its analysis including an assessment of the user's physical condition, recommendations, and special offers selected by the kiosk's processor based on the user's personal information and test results, such as product coupons. The user can also request information relating to a variety of issues (e.g., fitness, nutrition, weight loss, etc.) and products (e.g., magazines, health clubs, etc.).

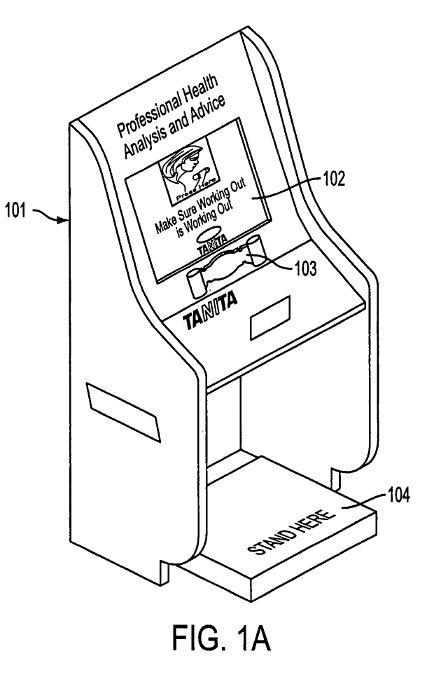

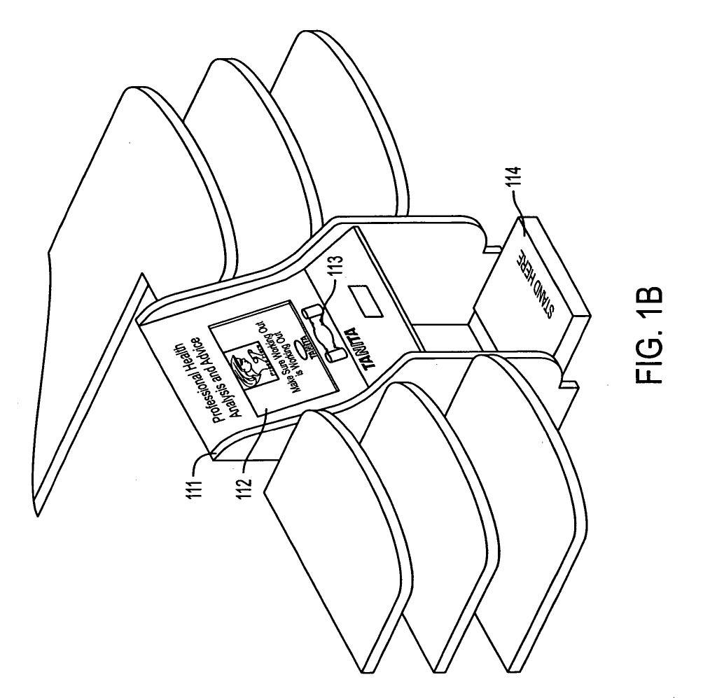

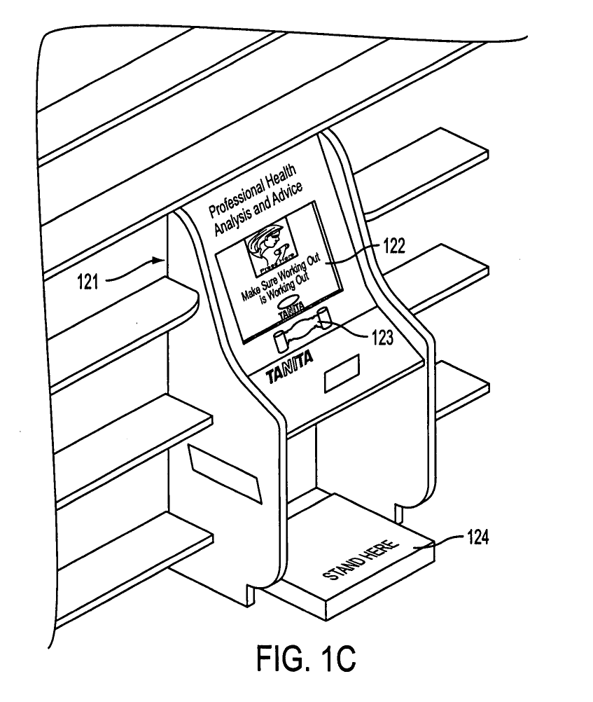

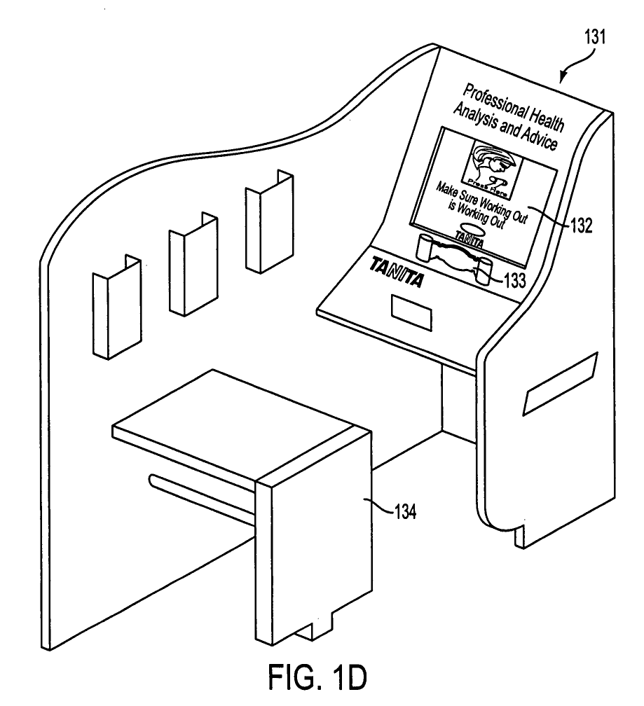

FIGS. 1a-1d illustrate devices according to various embodiments of the present invention in kiosk form. A stand alone kiosk 101 is shown in FIG. 1a, having a monitor 102 for displaying information and inputting data via a touch-screen, electrodes 103 which are gripped by a user to perform body fat measurements, and a scale 104 for measuring the weight of the user. A counter kiosk 111 is shown in FIG. 1a, having a monitor 112 for displaying information and inputting data via a touch screen, electrodes 113 which are gripped by a user to perform body fat measurements, and a scale 114 for measuring the weight of the user. An in-line kiosk 121 is shown in FIG. 1a, having a monitor 122 for displaying information and inputting data via a touch screen, electrodes 123 which are gripped by a user to perform body fat measurements, and and a scale 124 for measuring the weight of the user. A sit-down kiosk 131 is shown in FIG. 1a, having a monitor 132 for displaying information and inputting data via a touch screen, electrodes 133 which are gripped by a user to perform body fat measurements, and and a scale 134 for measuring the weight of the user.

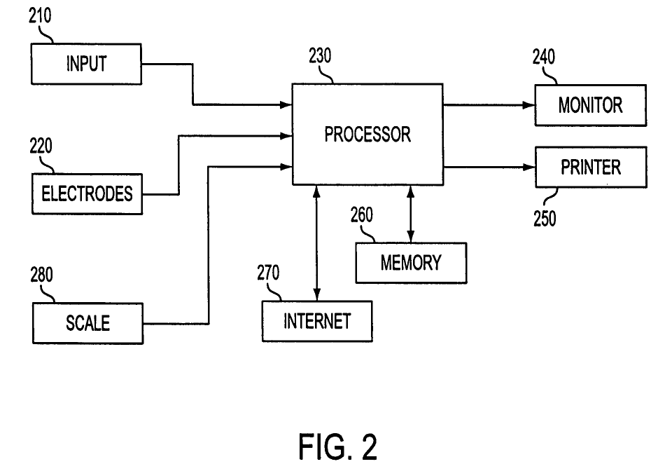

FIG. 2 is a block diagram of an apparatus 200 according to the present invention. An input device 210 for inputting personal data of a user, such as a keyboard or a touch screen, is in communication with a processor 230, such as a computer, which preferably performs the operations described herein electronically. A set of electrodes 220, such as for contacting the fingers of the user, is also connected to processor 230, as well as a scale 280, such as a conventional electronic scale, for measuring the weight of the user. Processor 230 includes circuitry for measuring body fat (e.g., body fat percentage, body fat ratio, etc.) of the user in a conventional manner. Those skilled in the art will recognize that one well-known body fat measuring technique that can be used in practicing the present invention involves the user contacting a set of electrodes, such as electrodes 220, with their skin, passing a current through the user, measuring the resulting impedance and calculating the user's body fat based on the impedance.

Apparatus 200 further includes a monitor 240 and a printer 250 connected to processor 230 for providing information to the user. Monitor 240 can be combined with input device 210 if input device 210 is a touch screen. Memory 260 is provided to store data to be displayed or printed as selected by processor 230, and to store personal information of the user. Processor 230 is also connected to an external network, such as via the internet 270.

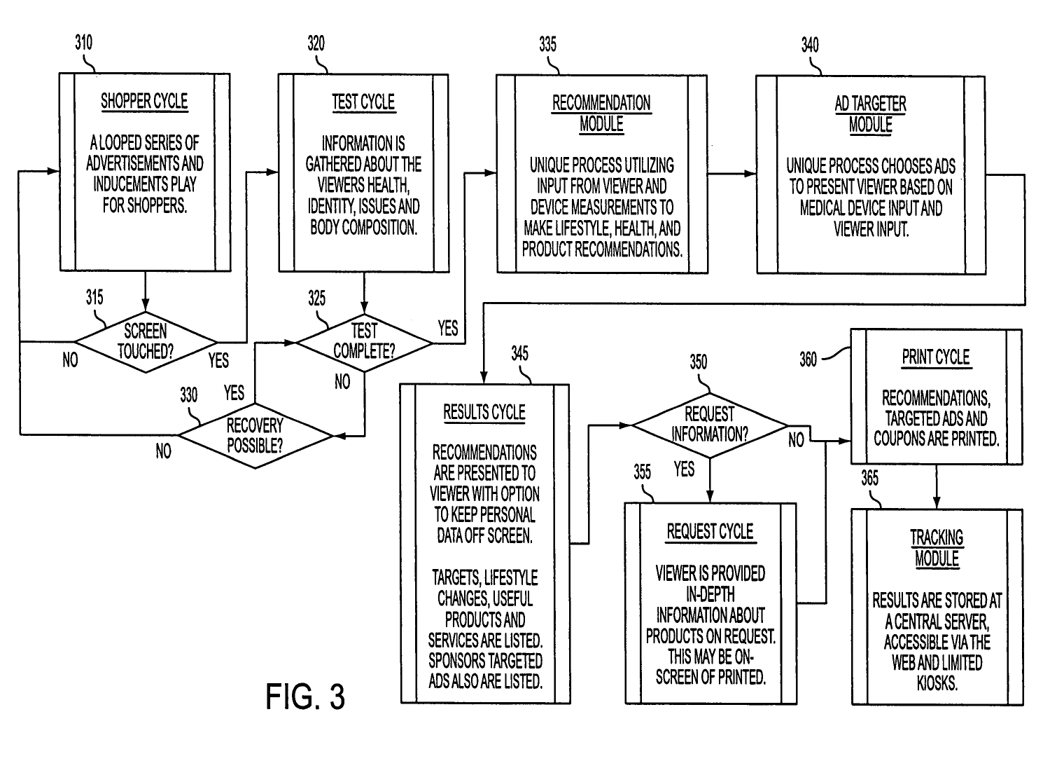

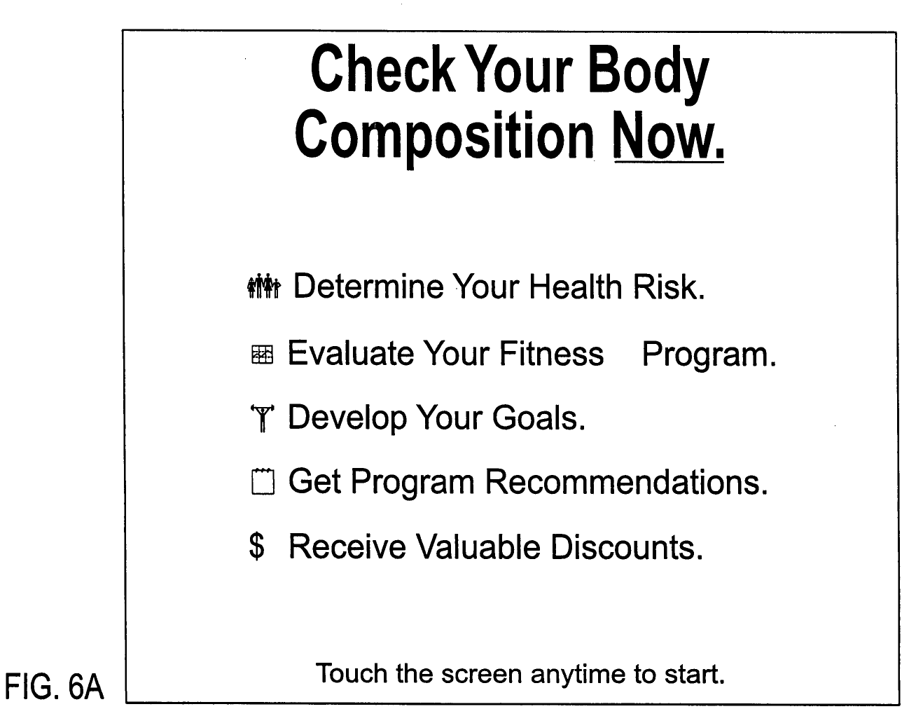

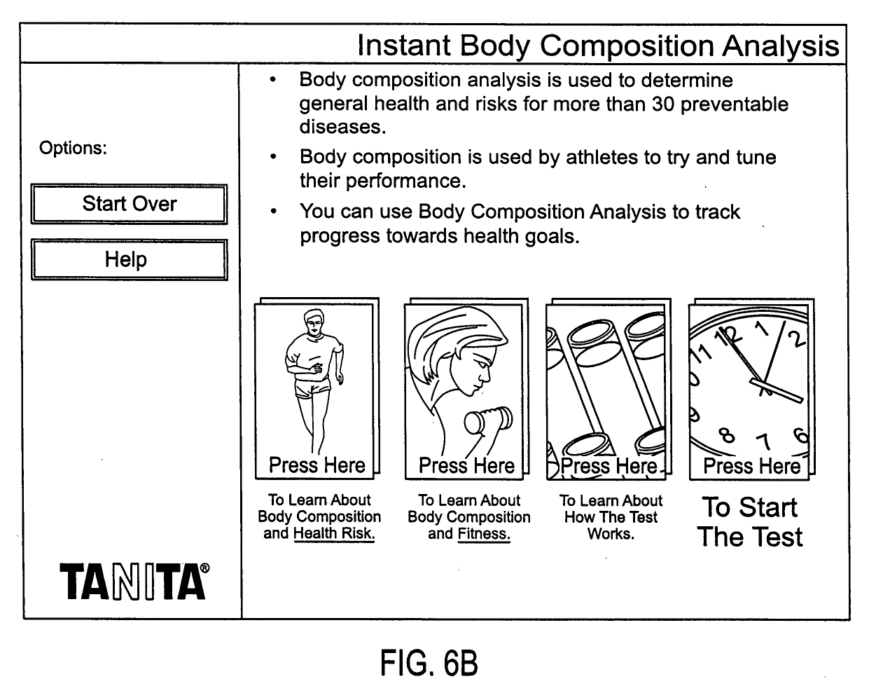

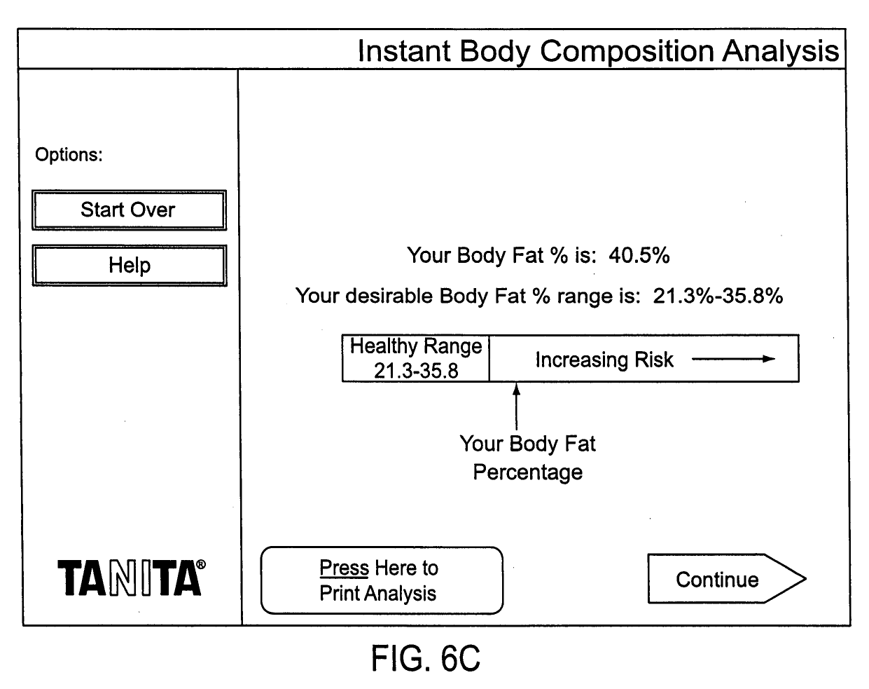

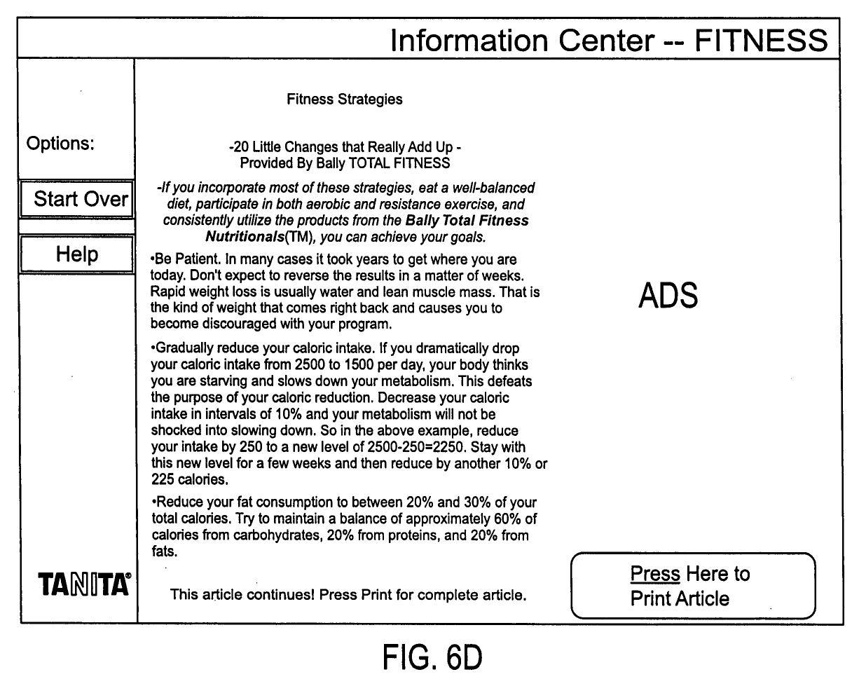

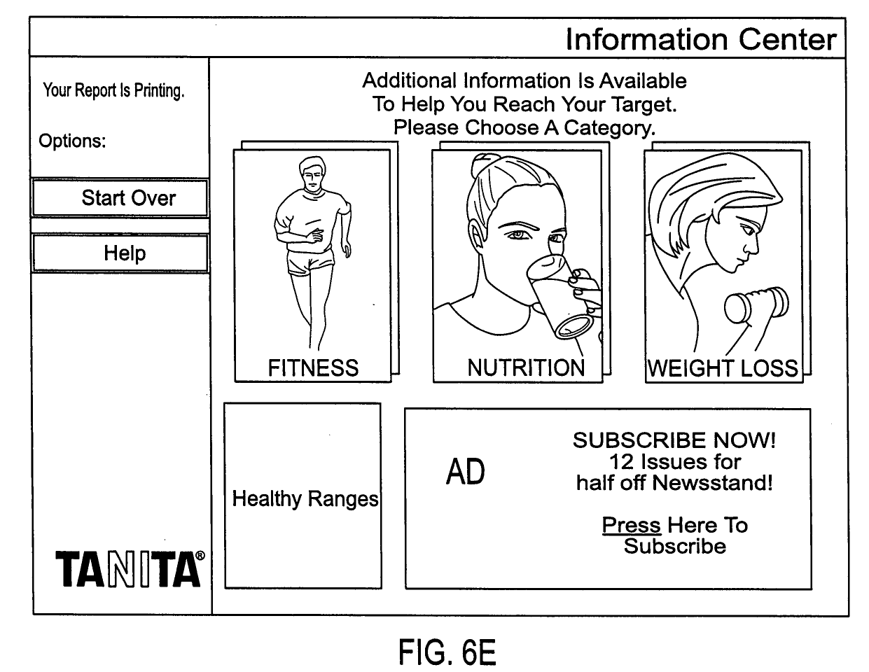

FIG. 3 is a flow chart illustrating an overview of an embodiment of the present invention. The user is presented a series of advertisements and inducements called the Shopper Cycle on a monitor, such as monitor 240, when the user approaches the inventive kiosk, such as a kiosk shown in FIGS. 1a-1d (see step 310). One such screen is illustrated at FIG. 6a. At step 315, if the user does not touch the screen, the Shopper Cycle continues. However, if the user touches the screen when prompted (see FIG. 6a), another screen, such as shown in FIG. 6b, appears to prompt the user to begin a Test Cycle (step 320), where information is gathered about the user's health, identity, and body composition, including conducting a body fat analysis. At step 325, if the test is not complete, it is determined at step 330 whether the test can be completed. If not, the test is aborted and the Shopper Cycle resumes.

When the test is complete, a Recommendation Module within processor 230 utilizes information inputted by the user and the user's body fat analysis to select lifestyle, health and product recommendations, such as are stored in memory 260 (see step 335). Processor 230 also has an Ad Targeter Module 340 for choosing advertisements to present to the user based on the input user information and body fat analysis. At step 345, the Results Cycle begins, wherein recommendations are presented to the viewer with the option to keep personal data off monitor 230. Fitness targets, lifestyle changes and useful products and services are listed, and advertisements and offers are displayed. An example of a body fat analysis result screen is shown in FIG. 6c, and an example of a recommendation, in the form of an article, is shown in FIG. 6d.

At step 350, the user has the option of requesting more information. If the user wants more information, the Request Cycle is begun at step 355, where the user is provided in-depth information regarding products, etc. A screen that allows the user to access additional information is shown in FIG. 6e. Whether or not the user requests more information, at step 360 the user can opt to have their test results and/or any other information printed. Results are stored at, for example, a central server that comprises memory 260 and is accessible via the internet and kiosks (see step 365).

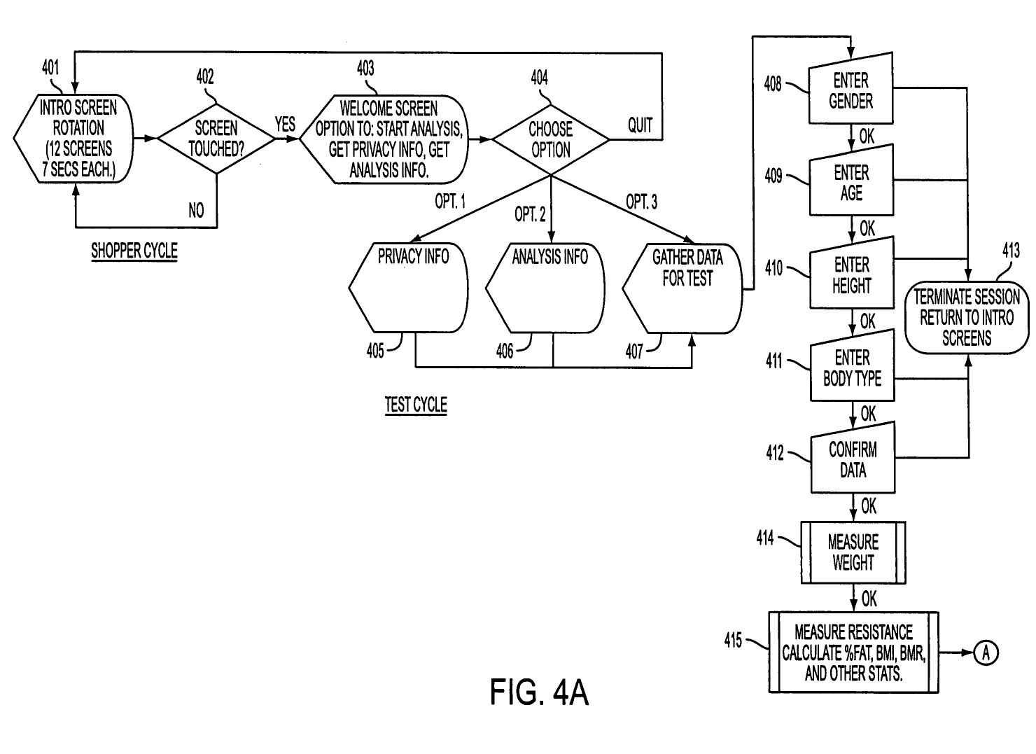

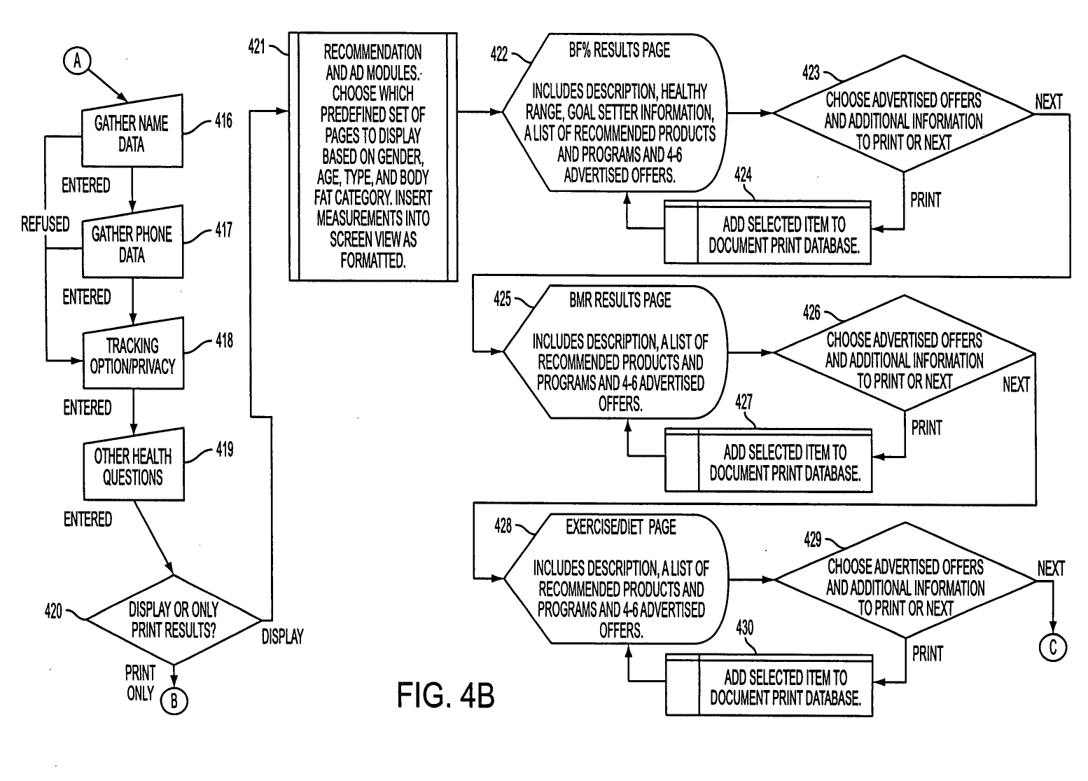

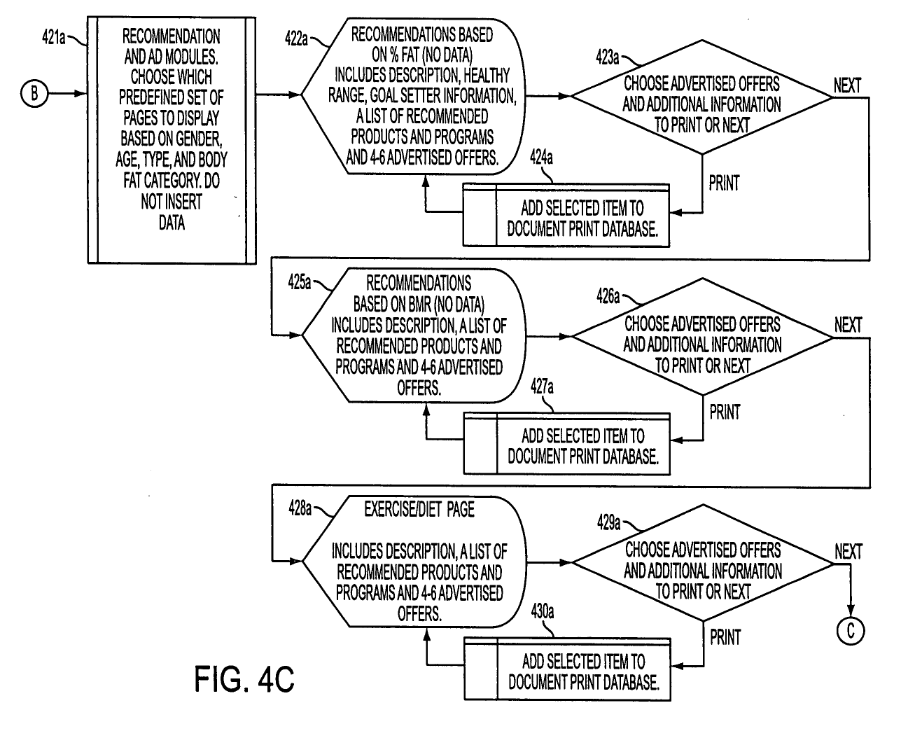

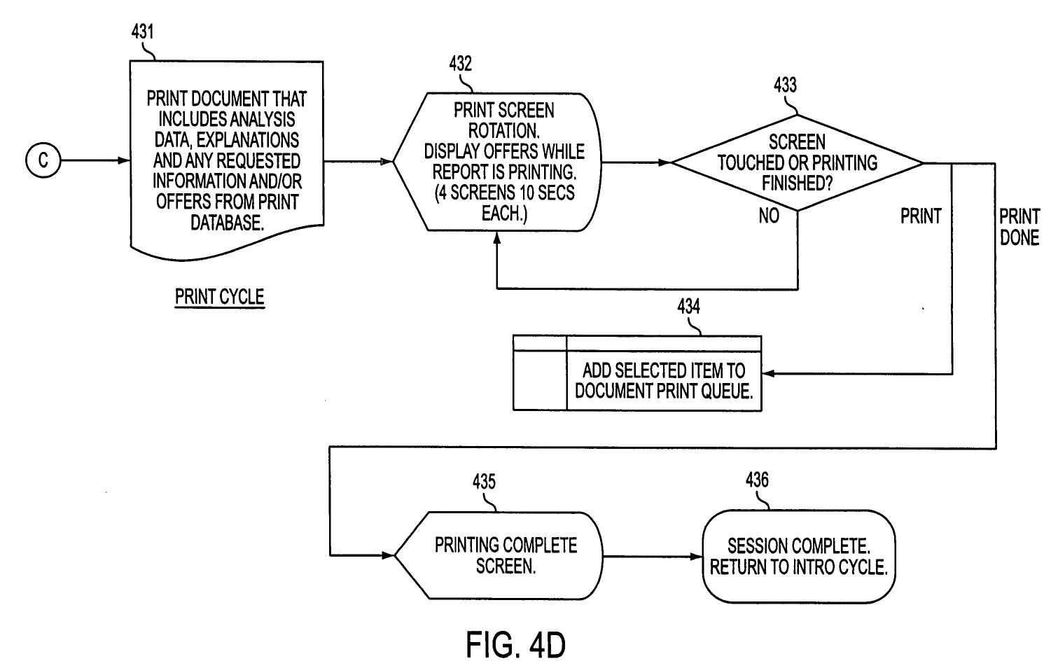

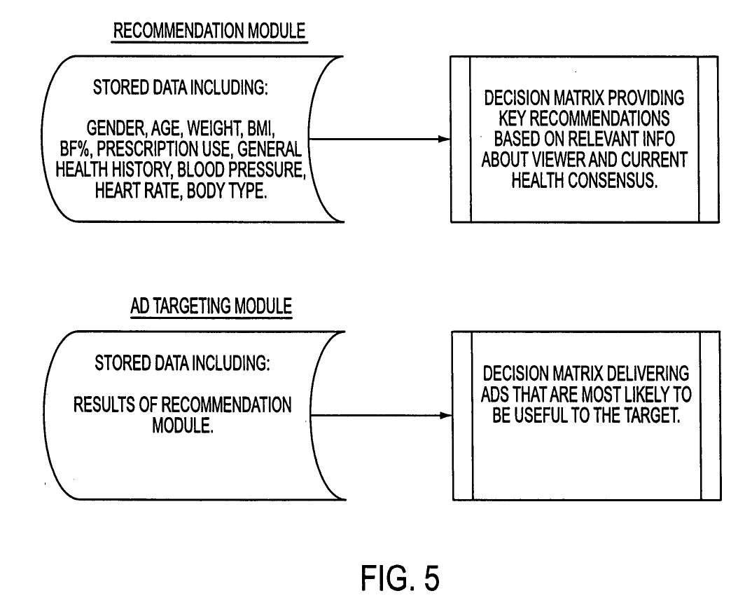

FIGS. 4a-d and FIG. 5 are flow charts illustrating an embodiment of the present invention in greater detail. Referring now to FIGS. 3 and 4a, steps 401 and 402 correspond to the Shopper Cycle of steps 310 and 315. If the user touches the screen when prompted at step 402, a Welcome Screen appears on monitor 240 at step 403, offering the user the option at step 404 to quit, to obtain privacy information (step 405) or information about the analysis to be done by the kiosk (step 406), or to begin the test (step 407). The user is then prompted to enter their gender, age, height and body type at steps 408-411, respectively, and to confirm the data at step 412. The user can terminate the session at any time (see step 413).

At step 414, the user's weight is measured by scale 280, and at step 415 the user is instructed to place their fingers on electrodes 220. The resulting resistance is measured, and the user's body fat percentage and other well-known fitness statistics, such as basal metabolic rate (BMR), are calculated in a conventional manner.

Referring now to FIG. 4b, the user's name and phone number are entered, if the user wishes to do so, at steps 416 and 417. The user's conventional privacy issues are addressed at step 418, and other health questions are presented to the user at step 419.

At step 420, the user has the option of displaying the test results or only printing the results. If the user chooses to have the results displayed, the Recommendation and Ad Targeter Modules (described above with reference to steps 335 and 340) of processor 230 select a predefined set of pages to display on monitor 240 based on the user's gender, age, body type and body fat results (see step 421). The Recommendation Module and Ad Targeter Module of processor 230 are shown in greater detail at FIG. 5.

At step 422, the Body Fat Percentage Results Page is displayed, which includes a description of the body fat analysis results as shown in FIG. 6c, a list of recommended products and programs, and a number of advertisements. At step 423, the user can choose to print the Results Page at step 424, wherein the selected items are added to a print database. When the user chooses “Next” at step 423, the BMR Results Page is displayed, which includes the results of the BMR calculation performed by processor 230, a list of recommended products and programs, and a number of advertisements. At step 426, the user can choose to print the BMR Results Page at step 427, wherein the selected items are added to a print database. When the user chooses “Next” at step 426, the Exercise/Diet Page is displayed, which includes a description of exercise and diet analysis results, a list of recommended products and programs, and a number of advertisements. At step 429, the user can choose to print the Exercise/Diet Page at step 430, wherein the selected items are added to a print database.

If the user chooses, at step 420, to only print the test results, processor 230 executes steps 421a-430a as shown in FIG. 4c. Steps 421a-430a correspond to steps 421-430, respectively, and are identical to steps 421-430 except that the user's test results are not displayed at steps 421a, 422a and 425a.

When the user chooses “Next” at step 429 or 429a, the Print Cycle begins at step 431 (see FIG. 4d), wherein all documents in the print database are printed. While the documents are being printed, advertisements such as special offers, coupons, etc. are displayed at monitor 240 (step 432), and the user has the option of printing any of the offers by touching the screen at step 433. The selected items are added to the print database and printed (step 434). When printing is complete at step 435, the Shopper Cycle (steps 401, 402) resumes.

The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only the preferred embodiment of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. An apparatus comprising:
an input device for inputting personal data of a user;
a body fat analyzer for measuring the body fat of the user;
an output device for providing information to the user; and
a processor for selecting the information based on the personal data and the body fat measurement of the user, and for providing the information to the output device;
wherein the information comprises at least one of commercial information and health-related information.
a processor for selecting the information based on the personal data and the body fat measurement of the user, and for providing the selected information to the output device;
wherein the selected information comprises [at least one of] the commercial [information] data [and health related information].
